(19) United States
(12) Patent Application Publication
(10) Pub. No.: US 2008/0104965 A1
(43) Pub. Date: May 8, 2008

(54) Energy Saving Telecommunications Shelter

(75) Inventor: Gerasimos Petratos, Athens (GR)

Correspondence Address: DARBY & DARBY P.C., P.O. BOX 770, Church Street Station, New York, NY, 10008-0770, US

(73) Assignee: PETCOR H/M ERGA - EFARMOGES KLIMATISMOU S.A., P. Faliro, Athens (GR)

(21) Appl. No.: 11/814,836

(22) PCT Filed: Jan. 26, 2006
(86) PCT No.: PCT/GR06/00003

§ 371 Date: Jul. 26, 2007

(30) Foreign Application Priority Data
Jan. 27, 2005 (GR) 2005 01 00039

(51) Int. Cl. F25B 21/02; F25B 27/00; G05D 23/19

(52) U.S. Cl. 62/3.6; 62/157; 62/259.2

(57) ABSTRACT

The energy-saving telecommunications shelter is used to reduce the electric energy consumed for the air-conditioning and the normal operation of the shelter. A part of the consumed energy is used to cool the cabin. The telecommunications shelter consists of 2 separate compartments, the telecommunications equipment installation compartment and the battery installation compartment. The separation of the compartments is effected using a double, metallic partition (1), intended for the thermal isolation of the 2 compartments. Cooling of the telecommunications equipment installation compartment is effected by an air-conditioning unit (2), equipped with a “free-cooling” system and a heater. Air-conditioning of the battery storage compartment is effected by two thermocouple-based cooling devices (3) and a heater (17). Energy savings are achieved owing to the separate adjusting of the temperature of each compartment according to the specifications of the equipment defined by the manufacturers, and to the combined operation of the air-conditioning devices of each compartment.

The present invention relates to shelters housing equipment suitable for emitting and receiving telecommunications signals, installed outdoors. These shelters are termed telecommunications shelters. Telecommunications shelters are used both for urban applications and for remote areas, not easily accessible to the specialized technicians.

The are constructed of metal panels, usually possessing a sufficiently thick heat-insulating layer, and suitably arranged to form a rectangular box. They are also provided, in the internal face of the panels, with a suitable layer of insulating material, in order to restrain heat exchanges to and from the interior of the shelter. Access to these shelters is effected through doors, commonly provided in the front side of the shelter.

To ensure proper operation of the enclosed sensitive telecommunications equipment, a constant temperature within secure limits must be maintained in the interior of the shelter. A rise in the internal temperature is caused by thermal loads dissipated from the electronic devices (telecommunications equipment) during their functioning. The situation is considerably worsened during summer, especially when the whole installation is situated in very exposed places, such as in building roofs, where the shelter is exposed to the solar radiation for several hours. Keeping the temperature within certain defined limits is a condition required by the specifications of the equipment as well as of the batteries of the power supplies.

More particularly, concerning the batteries, and according to their manufacturers, to keep their capacity within the nominal limits without at the same time decreasing their operational life, a defined and unique charging voltage must be applied.

Given that, in their majority, the power supplies lack the capability to correct the output voltage in relation to the prevailing temperature, efforts are made to keep constant, together with the output voltage of the power supply, the temperature of the batteries storage compartment.

The safe limits for the temperature of the batteries vary between 23° C. and 25° C., while for the working telecommunications equipments they are usually between 29° C. and 35° C.

Until this day, the telecommunications shelters had a unique space for the telecommunications equipment and for the batteries, and it is obvious that the requirement for a constant, low temperature (about 23° C.-25° C.) for the batteries, must apply to the totality of the shelter and creates a requirement to keep a lower constant temperature in a larger space than is actually necessary, impacting negatively on the energy consumption and the cost, as well as on the stress put on air conditioning apparatus, with all its implications.

Thus, in order to achieve a more rational utilization of the consumed energy, it is proposed to separate the batteries from the rest of the telecommunications equipment using a separating wall (1), (similar to that used for the external construction of the shelter), with the simultaneous broadening of the operating temperature limits of the space enclosing the active telecommunications equipment. This separation aims basically to the thermal isolation, while a simultaneous benefit is the avoidance of the accidental contact of the personnel with the batteries and of the access of non-competent persons into this area.

For the air-conditioning and the appropriate cooling of the room, we have at our disposal to select one of the conventional air-conditioning systems. What we are expecting from the cooling system is its reliable operation under the particularly increased requirements of the whole installation, an extended lifespan, energy savings, the decrease of the regular maintenance of the installation, and the respect of the environment.

For the particular application, in relation to telecommunications equipment installation compartment, which typically is about 2500 mm in length, 750 mm in width and 2050 mm in height, we select to install an air-conditioning apparatus operating with vapor compression (2), equipped with a “free cooling” control microprocessor. This particular device has a nominal power of 4 kW. The “free cooling” control microprocessor controls the operation of a damper which, when the outdoor temperature and humidity conditions are within the prescribed margin for the operation of the telecommunications equipment, allows the introduction of fresh air, in order to achieve proper cooling. That is, the internal space is conditioned using fresh air, when the outdoor conditions allow. Even when the cooling apparatus fails, the opening of the damper is ensured, by means of the “free-cooling” microprocessor, in such a way as to cool the telecommunications equipment space with fresh air entering from outdoors by means of a fan. The conditioning of the space, when heating is required, for example during the winter, is effected using electrical heating resistances installed inside the air-conditioning apparatus. Their operation is combined with that of the air-conditioner's fan.

Access to this space is through two-ply folding doors made of metal panels, with special safety locks.

For the battery installation compartment, and taking into account the fact that the required cooling power is small since the batteries dissipate small amounts of heat, we select to use a thermocouple-driven cooling device, also known as thermoelectric element or Peltier element (3). An important advantage of those devices is the limited dimensions, the small number of moving parts and the absence of preventive maintenance.

For the case where the outdoor temperature is low, such as for example during winter, the battery compartment is provided with an electric resistance heater with fan (17), which is suitably activated to heat the compartment. The battery installation compartment is situated at the right side of shelter and its internal dimensions are about 750 mm in length, 750 mm in width and 2050 mm in height. Access to this space is through two doors situated in the front and back side, respectively, made of metal panels.

A feature of the present invention is power savings, resulting in a decrease of the operational costs for the cabin cooling. The above feature is achieved by separating the battery installation compartment from the telecommunications installation compartment and by the combined operation of the two cooling devices. Specifically, the battery installation compartment, requiring a defined temperature, specified by the manufacturer, so as to ensure their optimal operation and longer lifespan, is cooled to a temperature which is different from that of the telecommunications equipment installation compartment. Thus, while the battery installation compartment is cooled to a defined temperature, the telecommunications equipment installation compartment may be cooled to a temperature which is higher by a few degrees Celsius. For instance, the temperature in the battery installation compartment may be adjusted at 25° C., while the temperature of the telecommunications equipment compartment may be as high as 29° C.

Power savings are achieved by setting the temperature of the cooling device of the telecommunications equipment compartment to a level higher than that required by the batteries. At the same time, with the combined use of the cooling devices the reliability of the overall air-conditioning system is enhanced, since the duration of its operation, and hence its wear, is less. The lifespan and the reliability of the air-conditioners is increased, and the number of breakdowns and the maintenance cost are decreased.

With that use, we achieve the storage of the batteries at the temperature specified by the manufacturer, to keep their capacity to a value close to the maximum possible.

Overall, the consumed energy per shelter is decreased, and thus also the operative cost, and if we take into account that the cost per kWh is lower as the total consumed energy is decreased, the percentage of money savings is expected to be higher than the corresponding energy saving.

From an overall and environmental viewpoint, the correct use of the invention decreases the pollutants released in the air due to the burning of fuel for power production, such as CO₂, sulfur- and nitrogen-containing compounds. An important advantage consists in the use, in the vapor compression-based air-conditioning unit, of refrigerant R407C, which is not causing irreversible damages to the atmosphere, as do the previously used R22 or R12 refrigerants.

According to another feature of the present invention, the construction of the telecommunications shelter is such that its damage due to attempts of destruction or infraction is minimized. This becomes possible because of the use of steel plates for its construction, and of the assembly of the plates using assemblage means applied from the inside of the shelter, so as to be inaccessible. We also select safety locks and hinges. Finally, on every door a terminal switch is installed, which is connected to the alarm system and is actuated and appropriately signals when any door is opened.

Another important element of the design of the shelter is the fact that it can be modular, so as it can easily be assembled and disassembled. In this way, a transfer of the shelter is possible, without excessive labor and in a short delay.

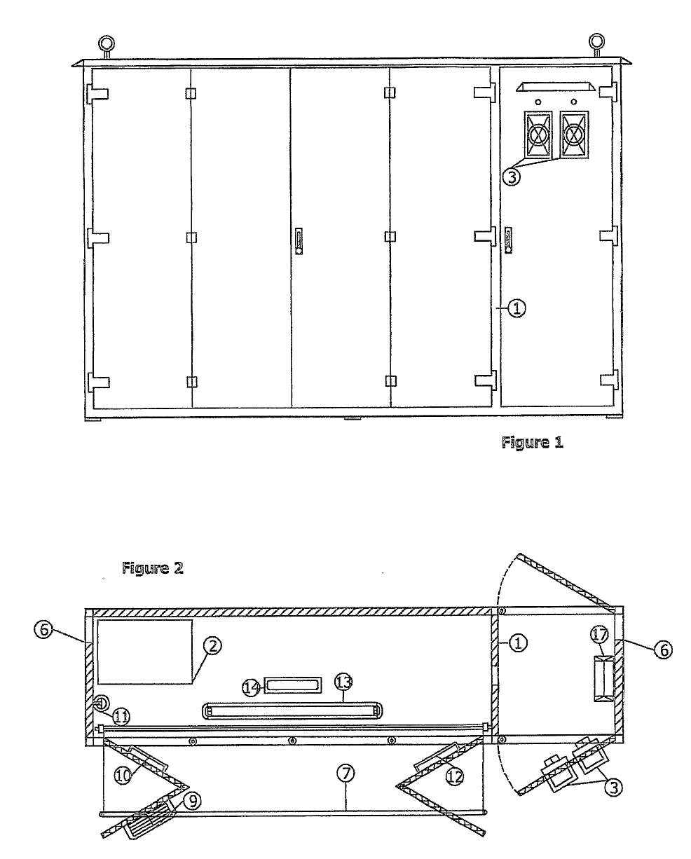

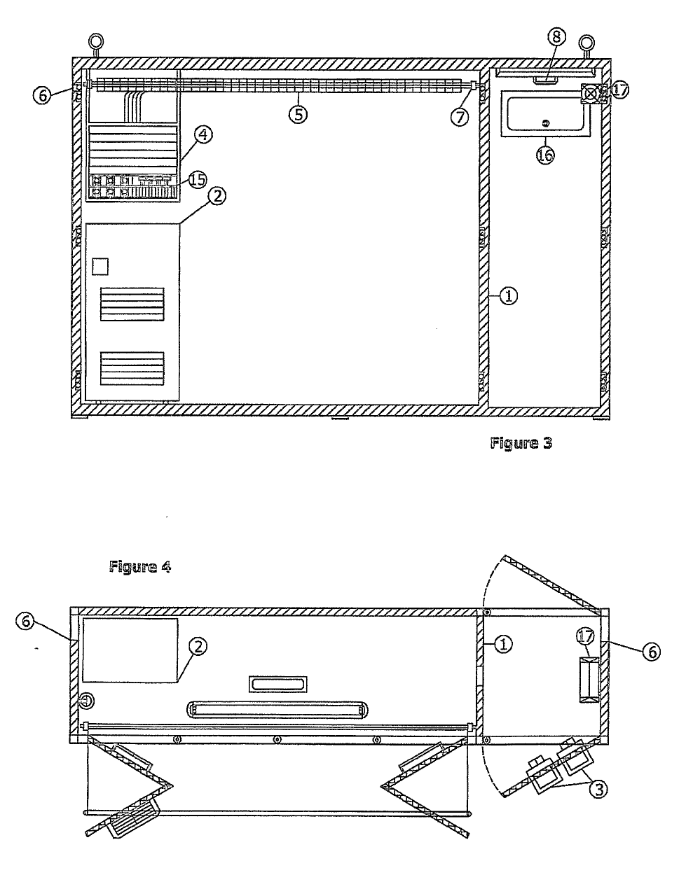

The invention is accompanied by a number of parts aiming at a safer, more regular and easier operation of the telecommunications shelter. These parts represent some of the features of the invention, and comprise:
A 19 inch metal cabinet (of the rack type) (4) for the installation of the telecommunications equipment, located at the left side of the telecommunications equipment installation compartment, FIG. 3.
A perforated metal cable-supporting grid (5) located at the upper part of the telecommunications equipment installation compartment, FIG. 3.
FIMO type stuffing-boxes (6) ensuring the isolation and the protection of the cables at the point of exit from the shelter's interior, located at the left and the right side of the shelter, FIG. 3.
A sunshade of waterproof fabric (7) that is rolled and stored inside the telecommunications equipment installation compartment, FIGS. 2 and 3.
A metal sunshade (8) protruding horizontally, supported on suitable shaped rails, on the top of the batteries installation compartment, FIG. 3.
A small ladder (9), mounted in special slots on the inside face of the left door, in the telecommunications equipment installation compartment, FIG. 2.
A first aid kit (10), mounted in special slots on the inside face of the left door, in the telecommunications equipment installation compartment, FIG. 2.
A fire extinguisher (11), located at the telecommunications equipment installation compartment, FIG. 2.
A small, foldable workbench (12) located on the inside face of the right door, in the telecommunications equipment installation compartment, FIG. 2.
A 36 W fluorescent lamp (13), installed on the ceiling of the telecommunications equipment installation compartment, FIG. 2.
A security lamp (14), installed on the ceiling of the telecommunications equipment installation compartment, FIG. 2.
An electrical distribution panel (15), located at the left side of the telecommunications equipment installation compartment, FIG. 3.
A small storage compartment (16), located at the upper part of the batteries installation compartment, FIG. 3.
A fan heater (17) for the heating of the batteries compartment when the outdoor temperature is exceedingly low, FIG. 2.

The present invention will be better understood from the accompanying FIGS. 1, 2, 3, and 4, wherein all the above parts are shown in detail. The figures are as follows:

FIG. 1: is a front view of the telecommunications shelter, with all the doors leading to the inside closed. On this figure are shown the position of the double, metallic separating wall (1) and the two thermocouple-based cooling devices (3), mounted on the upper part of door leading to the battery compartment.

FIG. 2: is a top view of the telecommunications shelter, of the telecommunications equipment installation compartment and of the battery installation compartment. In this are shown the double, metallic separating wall (1), the “free-cooling” type air-conditioning unit (2), its installation location, the two thermocouple-based cooling devices (3), all the shelter's doors and their direction of opening, as well as a large number of other parts of the interior space.

FIG. 3: is a front view of the telecommunications shelter, with all front side doors open so that the interior of the shelter is visible, in which are shown the double, metallic separating wall (1), the “free-cooling” type air-conditioning unit (2), its installation location, the 19 inch cabinet (4), the electrical power distribution panel (15), the perforated metal cable-supporting grid (5), the sunshade made of waterproof fabric (7) that is rolled and stored in the telecommunications equipment installation compartment, the metallic sunshade in the battery compartment (8), and a small storage compartment (closet) in the battery compartment (16).

FIG. 4: is a top view of the telecommunications shelter.

1. (canceled)

2. Telecommunications shelter (1) containing active telecommunications equipment, a bank of back-up batteries (11), one or more cooling devices to remove the excess heat generated by the operation of the active telecommunications equipment, and means to control the operation of said cooling devices in order to maintain the appropriate range of operating temperatures for both the active telecommunications equipment and the back-up batteries (11);
wherein said telecommunications shelter further comprises
insulating wall means to thermally isolate a telecommunications equipment compartment from a battery compartment; and
means comprising separate active cooling devices to separately control the temperature of said telecommunications equipment compartment and of said battery compartment, in order to maintain different temperature conditions inside said battery compartment from those maintained inside said telecommunications equipment compartment.

3. Telecommunications shelter according to claim 2, wherein said separate active cooling device of the battery department consists of DC thermoelectric (Peltier) elements (3).

4. Telecommunications shelter according to claim 2, wherein said separate active cooling device (2) of the telecommunications equipment comprises a “free cooling” subsystem.

5. Telecommunications shelter according to claim 3, wherein said separate active cooling device (2) of the telecommunications equipment comprises a “free cooling” subsystem.
